(19) United States
(12) Patent Application Publication
(10) Pub. No.: US 2014/0238240 A1
(43) Pub. Date: Aug. 28, 2014

(54) DOWNFLOW DUST COLLECTORS HAVING DIRTY AIR CHANNELS

(71) Applicant: Donaldson Company, Inc., Minneapolis, MN (US)

(72) Inventor: Thomas D. Raether, St. Louis Park, MN (US)

(73) Assignee: Donaldson Company, Inc., Minneapolis, MN (US)

(21) Appl. No.: 14/186,414

(22) Filed: Feb. 21, 2014

Related U.S. Application Data
(60) Provisional application No. 61/768,291, filed on Feb. 22, 2013.

(51) Int. Cl. B01D 46/00; B01D 46/04; B01D 46/02

(52) U.S. Cl. CPC B01D 46/0041; B01D 46/02; B01D 46/002; B01D 46/04
USPC 95/273; 55/495; 55/484; 55/350.1; 55/301

(57) ABSTRACT

Dust collectors having one or more dirty air channels and a clean air plenum having upper and lower clean air chambers are described herein along with related methods.

### RELATED APPLICATION

This application claims the benefit under 35 U.S.C. §119 of U.S. Provisional Patent Application No. 61/768,291 filed on Feb. 22, 2013 and titled DOWNFLOW DUST COLLECTORS HAVING DIRTY AIR CHANNELS, which is incorporated herein by reference in its entirety.

Dust collectors having one or more dirty air channels and a clean air plenum having upper and lower clean air chambers are described herein along with related methods.

Dust collectors are used, e.g., to clean particulate matter from air flow streams. One embodiment of dust collectors includes bag house filters. Bag house filters include a housing, a dirty air inlet, a clean air outlet, and a tubesheet having a plurality of apertures. The tubesheet separates the housing between a dirty air side and a clean air side and holds the filter bags. The bags are made of a filter media so that as dirty air flows from the dirty air side to the clean air side, the air must flow through the bags, and the filter media of the bags prevents particulate matter from reaching the clean air side.

Another embodiment of dust collectors that is known includes the use of filter cartridges having pleated media. The filter cartridges are held by a tubesheet, and the air must flow through the pleated media of the filter cartridges from the dirty air side to the clean air side.

### SUMMARY

Dust collectors having one or more dirty air channels and a clean air plenum having upper and lower clean air chambers are described herein along with related methods. The dirty air channels define, in one or more embodiments, a dirty air flow axis along which dirty air flows from the dirty air channels into the dirty air chambers of the dust collectors. The dirty air channels are, in one or more embodiments, configured such that dirty air entering the dirty air chambers from the dirty air channels along the dirty air flow axes cannot directly impinge on the dirty air faces of filter cartridges in the dirty air chambers without changing direction in the dirty air chambers.

In one or more embodiments of the dust collectors described herein, the dirty air faces of filter cartridges may form included angles with the dirty air flow axes defined by the dirty air channels that are equal to or greater than zero degrees. In one or more embodiments, the dirty air faces of filter cartridges may be parallel to the dirty air flow axes defined by the dirty air channels. Such arrangements may, in one or more embodiments, be advantageous because particulate matter entrained in the dirty air flow may be less likely to directly impinge on the filter material forming the dirty air faces of the filter cartridges while moving along the dirty air flow axes at higher velocities while leaving the dirty air channels and entering the dirty air chambers. Limiting that direct, higher velocity contact between particulates in the dirty air and the filter media may, in one or more embodiments, enhance the service life of filter cartridges in dust collectors as described herein.

In one aspect, one or more embodiments of a dust collector as described herein may include: a plurality of apertures formed through a tubesheet structure located in a housing, wherein the plurality of apertures comprise a first aperture and a second aperture; and a plurality of filter cartridges located in the housing, wherein the plurality of filter cartridges are positioned such that air passing through the plurality of apertures in the tubesheet structure must pass through at least one filter cartridge of the plurality of filter cartridges, wherein the tubesheet structure and the plurality of filter cartridges separate the housing into a clean air plenum and a dirty air plenum, and wherein the plurality of filter cartridges comprises a first filter cartridge and a second filter cartridge, and further wherein air passing through the first aperture must pass through a the first filter cartridge and air passing through the second aperture must pass through the second filter cartridge. The dirty air plenum comprises a dirty air channel located above a dirty air chamber, wherein the dirty air channel is located between a dirty air inlet through which dirty air enters the dirty air plenum and the dirty air chamber, wherein the dirty air chamber is located below a top of the first filter cartridge, and wherein the dirty air channel defines a dirty air flow axis through the dirty air channel. The clean air plenum comprises an upper clean air chamber located above the top of the first filter cartridge and a lower clean air chamber located below the upper clean air chamber and the top of the first filter cartridge, wherein the first filter cartridge comprises a dirty air face facing away from the lower clean air chamber, and wherein dirty air moving through the dirty air channel from the dirty air inlet to the dirty air chamber along the dirty air flow axis flows past the upper clean air chamber. Dirty air passing through the dirty air channel along the dirty air flow axis moves past a top of the first filter cartridge before reaching the dirty air chamber. The dirty air channel is configured such that dirty air entering the dirty air chamber from the dirty air channel along the dirty air flow axis cannot directly impinge on the dirty air face of the first filter cartridge without changing direction in the dirty air chamber.

In one or more embodiments of the dust collectors, dirty air passing through the dirty air channel along the dirty air flow axis moves past a top of the second filter cartridge before reaching the dirty air chamber.

In one or more embodiments of the dust collectors, the clean air plenum comprises: a first lower clean air chamber located below the top of the first filter cartridge and the first aperture in the tubesheet, wherein a clean air face of the first filter cartridge faces the first lower clean air chamber, and wherein the dirty air face of the first filter cartridge faces away from the first lower clean air chamber; and a second lower clean air chamber located below the top of the second filter cartridge and the second aperture in the tubesheet, wherein a clean air face of the second filter cartridge faces the second lower clean air chamber, and wherein a dirty air face of the second filter cartridge faces away from the second lower clean air chamber.

In one or more embodiments of the dust collectors, the first filter cartridge comprises a tubular filter cartridge comprising a cartridge opening located over the first aperture in the tubesheet, and wherein the second filter cartridge comprises a tubular filter cartridge comprising a cartridge opening located over the second aperture in the tubesheet.

In one or more embodiments of the dust collectors, a portion of the dirty air face of the first filter cartridge faces the dirty air flow axis, and wherein the dirty air flow axis is parallel with the portion of the dirty air face of the first filter cartridge or forms an included angle equal to or greater than zero degrees with the portion of the dirty air face of the first filter cartridge, wherein the included angle opens in the downward direction towards the dirty air chamber. In one or more embodiments, the dirty air flow axis forms an included angle of 75 degrees or less with the portion of the dirty air face of the first filter cartridge.

In one or more embodiments of the dust collectors, a clean air face of the first filter cartridge faces the lower clean air chamber, and wherein a clean air face of the second filter cartridge faces the lower clean air chamber. In one or more embodiments, the clean air face of the first filter cartridge faces the clean air face of the second filter cartridge across the lower clean air chamber.

In one or more embodiments of the dust collectors, the first filter cartridge comprises a flat dirty air face facing the dirty air flow axis, and wherein the dirty air flow axis is parallel with the flat dirty air face of the first filter cartridge or forms an included angle equal to or greater than zero degrees with the flat dirty air face of the first filter cartridge, wherein the included angle opens in the downward direction towards the dirty air chamber. In one or more embodiments, the dirty air flow axis forms an included angle of 75 degrees or less with the flat dirty air face of the first filter cartridge.

In one or more embodiments of the dust collectors, the dirty air plenum comprises a plurality of dirty air channels located above the dirty air chamber, wherein the plurality of dirty air channels comprises a first dirty air channel and a second dirty air channel, wherein dirty air flowing through the first dirty air channel defines a first dirty air flow axis and dirty air flowing through the second dirty air channel defines a second dirty air flow axis. Dirty air moving through the first dirty air channel from the dirty air inlet to the dirty air chamber along the first dirty air flow axis flows past the upper clean air chamber before flowing past the top of the first filter cartridge, and wherein dirty air moving through the second dirty air channel from the dirty air inlet to the dirty air chamber along the second dirty air flow axis flows past the upper clean air chamber before flowing past a top of the second filter cartridge. In one or more embodiments, the first dirty air channel is located on a first side of the upper clean air chamber and the second dirty air channel is located on a second side of the upper clean air chamber. In one or more embodiments, the first dirty air channel is separate and independent of the second dirty air channel such that dirty air passing through the first dirty air channel must enter the dirty air chamber before it can enter the second dirty air channel.

In one or more embodiments of the dust collectors, the first dirty air channel comprises a first dirty air inlet and the second dirty air channel comprises a second dirty air inlet, and further wherein the first dirty air inlet is separate and independent of the second dirty air inlet such that dirty air passing through the first dirty air inlet cannot enter the second dirty air channel unless it passes through the dirty air chamber first and dirty air passing through the second dirty air inlet cannot enter the first dirty air channel unless it passes through the dirty air chamber first.

In one or more embodiments of the dust collectors, a clean air face of the first filter cartridge faces the lower clean air chamber and a clean air face of the second filter cartridge faces the lower clean air chamber.

In one or more embodiments of the dust collectors, a clean air face of the first filter cartridge faces a clean air face of the second filter cartridge across the lower clean air chamber.

In one or more embodiments of the dust collectors, the first filter cartridge comprises a flat dirty air face, and wherein the first dirty air flow axis is parallel with the flat dirty air face of the first filter cartridge or forms an included angle equal to or greater than zero degrees with the flat dirty air face of the first filter cartridge, wherein the included angle opens in the downward direction towards the dirty air chamber. In one or more embodiments, the first dirty air flow axis forms an included angle of 75 degrees or less with the flat dirty air face of the first filter cartridge.

In one or more embodiments of the dust collectors, the dust collector further comprises a pulse jet cleaning system comprising a plurality of valves configured to deliver pulses of cleaning gas into the clean air plenum.

In one aspect, one or more embodiments of a dust collector as described herein may include: a plurality of apertures formed through a tubesheet structure located in a housing, wherein the plurality of apertures comprise a first aperture, a second aperture, a third aperture, and a fourth aperture; and a plurality of filter cartridges located in the housing, wherein the plurality of filter cartridges are positioned such that air passing through the plurality of apertures in the tubesheet structure must pass through at least one filter cartridge of the plurality of filter cartridges, wherein the tubesheet structure and the plurality of filter cartridges separate the housing into a first clean air plenum, a second clean air plenum, and a dirty air plenum, and wherein the plurality of filter cartridges comprises a first filter cartridge, a second filter cartridge, a third filter cartridge, and a fourth filter cartridge, and further wherein air passing through the first aperture into the first clean air plenum must pass through the first filter cartridge, air passing through the second aperture into the first clean air plenum must pass through the second filter cartridge, air passing through the third aperture into the second clean air plenum must pass through the third filter cartridge, and air passing through the fourth aperture into the second clean air plenum must pass through the fourth filter cartridge, and further wherein the first filter cartridge comprises a dirty air face facing away from the first clean air plenum, the second filter cartridge comprises a dirty air face facing away from the first clean air plenum, the third filter cartridge comprises a dirty air face facing away from the second clean air plenum, and the fourth filter cartridge comprises a dirty air face facing away from the second clean air plenum. The first clean air plenum comprises a first upper clean air chamber located above a top of the first filter cartridge, and wherein the second clean air plenum comprises a second upper clean air chamber located above a top of the third filter cartridge. The dirty air plenum comprises a plurality of dirty air channels located above a dirty air chamber, wherein each dirty air channel of the plurality of dirty air channels is located between a dirty air inlet and the dirty air chamber, and wherein a first dirty air channel of the plurality of dirty air channels is located between the first upper clean air chamber and a first sidewall of the housing, a second dirty air channel of the plurality of dirty air channels is located between the first and second upper clean air chambers, and a third dirty air channel of the plurality of dirty air channels is located between the second upper clean air chamber and a second sidewall of the housing, and wherein the first dirty air flow channel defines a first dirty air flow axis, the second dirty air flow channel defines a second dirty air flow axis, and the third dirty air flow channel defines a third dirty air flow axis. The first dirty air channel is configured such that dirty air entering the dirty air chamber along the first dirty air flow axis from the first dirty air channel cannot directly impinge on the dirty air face of any of the first filter cartridge, the second filter cartridge, the third filter cartridge, or the fourth filter cartridge without changing direction in the dirty air chamber. The second dirty air channel is configured such that dirty air entering the dirty air chamber along the second dirty air flow axis from the second dirty air channel cannot directly impinge on the dirty air face of any of the first filter cartridge, the second filter cartridge, the third filter cartridge, or the fourth filter cartridge without changing direction in the dirty air chamber. The third dirty air channel is configured such that dirty air entering the dirty air chamber along the third dirty air flow axis from the third dirty air channel cannot directly impinge on the dirty air face of any of the first filter cartridge, the second filter cartridge, the third filter cartridge, or the fourth filter cartridge without changing direction in the dirty air chamber.

In one or more embodiments of the dust collectors, the first dirty air channel, the second dirty air channel, and the third dirty air channel are all separate and independent from each other such that dirty air passing through the first dirty air channel must enter the dirty air chamber before it can enter the second dirty air channel or the third dirty air channel.

In one or more embodiments of the dust collectors, the first dirty air channel comprises a first dirty air inlet, the second dirty air channel comprises a second dirty air inlet, and the third dirty air channel comprises a third dirty air inlet, and further wherein the first dirty air inlet, the second dirty air inlet, and the third dirty air inlet are separate and independent from each other such that dirty air passing through the first dirty air inlet cannot enter the second dirty air channel or the third dirty air channel unless it passes through the dirty air chamber first, wherein dirty air passing through the second dirty air inlet cannot enter the first dirty air channel or the third dirty air channel unless it passes through the dirty air chamber first, and wherein dirty air passing through the third dirty air inlet cannot enter the first dirty air channel or the second dirty air channel unless it passes through the dirty air chamber first.

In one or more embodiments of the dust collectors, the first clean air plenum comprises a first lower clean air chamber located below the first upper clean air chamber, wherein a clean air face of the first filter cartridge faces a clean air face of the second filter cartridge across the first lower clean air chamber of the first clean air plenum; and the second clean air plenum comprises a second lower clean air chamber located below the second upper clean air chamber, wherein a clean air face of the third filter cartridge faces a clean air face of the fourth filter cartridge across the second lower clean air chamber of the second clean air plenum.

In one or more embodiments of the dust collectors, the first filter cartridge comprises a flat dirty air face, and wherein the first dirty air flow axis is parallel with the flat dirty air face of the first filter cartridge or forms a first included angle equal to or greater than zero degrees with the flat dirty air face of the first filter cartridge, wherein the first included angle opens in the downward direction towards the dirty air chamber.

In one or more embodiments of the dust collectors, a second filter cartridge comprises a flat dirty air face, and wherein the second dirty air flow axis is parallel with the flat dirty air face of the second filter cartridge or forms a second included angle equal to or greater than zero degrees with the flat dirty air face of the second filter cartridge, wherein the second included angle opens in the downward direction towards the dirty air chamber; and a third filter cartridge comprises a flat dirty air face, and wherein the second dirty air flow axis is parallel with the flat dirty air face of the third filter cartridge or forms a third included angle equal to or greater than zero degrees with the flat dirty air face of the third cartridge, wherein the third included angle opens in the downward direction towards the dirty air chamber.

In one or more embodiments of the dust collectors, a fourth filter cartridge comprises a flat dirty air face, and wherein the third dirty air flow axis is parallel with the flat dirty air face of the fourth filter cartridge or forms a fourth included angle equal to or greater than zero degrees with the flat dirty air face of the fourth filter cartridge, wherein the fourth included angle opens in the downward direction towards the dirty air chamber.

In one or more embodiments of the dust collectors, one or more of the first, second, third, and fourth included angles is 75 degrees or less.

In one or more embodiments of the dust collectors, the dust collector further comprises a first pulse jet cleaning system comprising a first plurality of valves configured to deliver pulses of cleaning gas into the first clean air plenum, and a second pulse jet cleaning system comprising a second plurality of valves configured to deliver pulses of cleaning gas into the second clean air plenum.

In one or more embodiments of the dust collectors, clean air exits from the first clean air plenum through a first clean air outlet, and wherein clean air exits from the second clean air plenum through a second clean air outlet.

In a third aspect, one or more embodiments of the methods described herein include using a dust collector as described herein to remove particulates from dirty air.

One or more embodiments of dust collectors described herein may have as few as one dirty air inlet, two dirty air inlets, or four or more dirty air inlets, each of which leads to a dirty air channel in the dust collector as described herein. One or more embodiments of dust collectors as described herein may include as few as one clean air outlet, or three or more clean air outlets. One or more embodiments of the dust collectors described herein may include any number of filter cartridges, with each filter cartridge being located over one or more apertures in a tubesheet.

If used herein, the words “preferred” and “preferably” refer to embodiments described herein that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein and in the appended claims, the singular forms “a,” “an,” and “the” include plural referents unless the context clearly dictates otherwise. Thus, for example, reference to “a” or “the” component may include one or more of the components and equivalents thereof known to those skilled in the art. Further, the term “and/or” means one or all of the listed elements or a combination of any two or more of the listed elements.

It is noted that the terms “comprises” and variations thereof do not have a limiting meaning where these terms appear in the accompanying description. Moreover, “a,” “an,” “the,” “at least one,” and “one or more” are used interchangeably herein.

Relative terms such as above, below, left, right, forward, rearward, top, bottom, side, upper, lower, horizontal, vertical, and the like may be used herein and, if so, are from the perspective observed in the particular figure. As used herein, above and below are used with reference to the general direction of gravity as it acts on the components being described.

The above summary is not intended to describe each embodiment or every implementation of the dust collectors and related methods as described herein. Rather, a more complete understanding of the invention will become apparent and appreciated by reference to the following Description of Illustrative Embodiments and claims in view of the accompanying figures of the drawing.

### BRIEF DESCRIPTIONS OF THE FIGURES OF THE DRAWING

FIG. 1 is a front perspective view of one illustrative embodiment of a dust collector as described herein.

FIG. 2 is a rear perspective view of the dust collector of FIG. 1.

FIG. 3 is a front view of the dust collector of FIG. 1, with the front wall of the housing removed to expose the interior of the dust collector.

FIG. 4 is an enlarged front view of the dust collector as depicted in FIG. 3.

FIG. 5 is a perspective view of another illustrative embodiment of a dust collector as described herein.

FIG. 6 is a side view of another illustrative embodiment of a dust collector as described herein.

FIG. 7 is a front view of the dust collector depicted in FIG. 6 (taken from the left side of FIG. 6) with the front portion of the housing removed to expose the interior of the dust collector.

### DESCRIPTION OF ILLUSTRATIVE EMBODIMENTS

In the following description of illustrative embodiments, reference is made to the accompanying figures of the drawing which form a part hereof, and in which are shown, by way of illustration, specific embodiments. It is to be understood that other embodiments may be utilized and structural changes may be made without departing from the scope of the present invention.

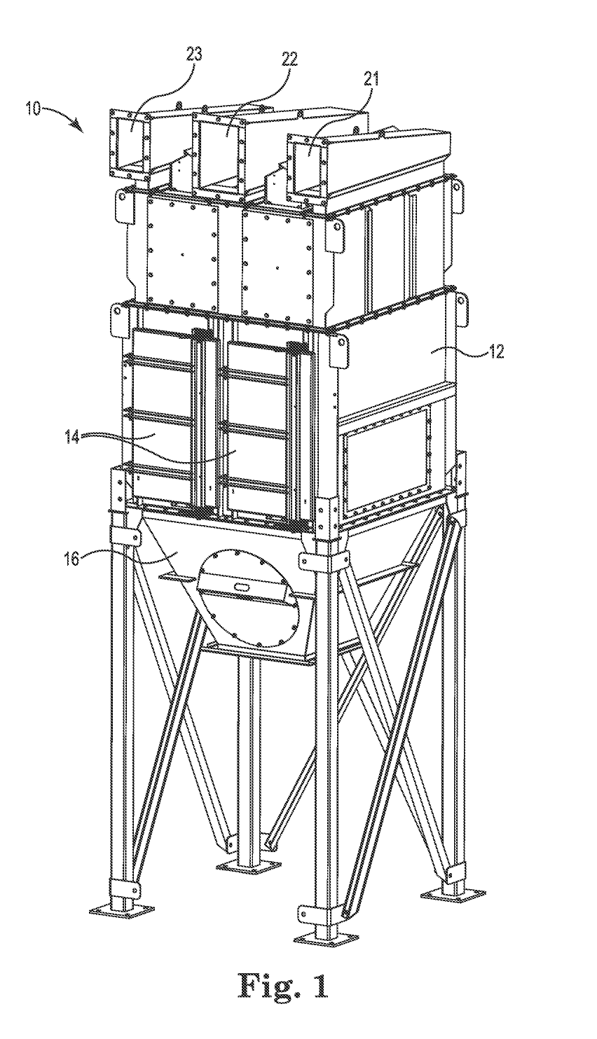

One illustrative embodiment of a dust collector 10 as described herein is depicted in FIGS. 1-4. The dust collector 10 uses filter cartridges to remove dust and other types of particulate from air. In general, the dust collector 10 includes a housing 12 made from sheet metal or other types of materials that are impermeable to air moving through the dust collector 10. The housing 12 may include access doors 14 as depicted in FIG. 1 to allow access to the interior of the housing 12 for replacement of the filter cartridges contained therein, as well as other maintenance requirements.

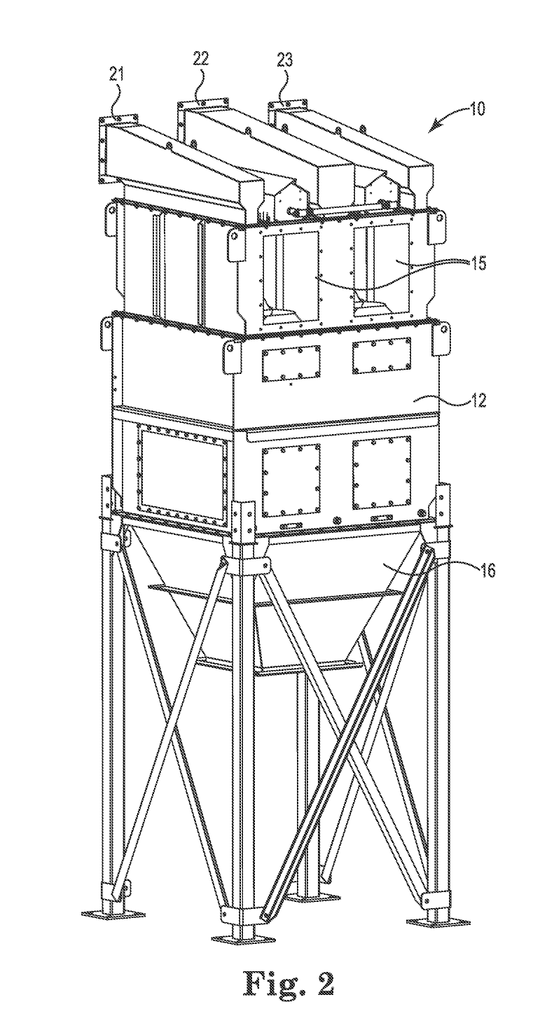

The dust collector 10 as depicted in FIGS. 1 and 2 includes, in one or more embodiments, multiple dirty air inlets 21, 22, and 23. Although the depicted embodiment includes three dirty air inlets, one or more alternative embodiments of dust collectors as described herein may have as few as one dirty air inlet, two dirty air inlets, or four or more dirty air inlets, each of which leads to a dirty air channel in the dust collector as described herein. As best seen in FIG. 2, the dust collector 10 also includes two filtered or clean air outlets 15. Although the depicted embodiment includes two clean air outlets, one or more alternative embodiments of dust collectors as described herein may include as few as one clean air outlet, or three or more clean air outlets.

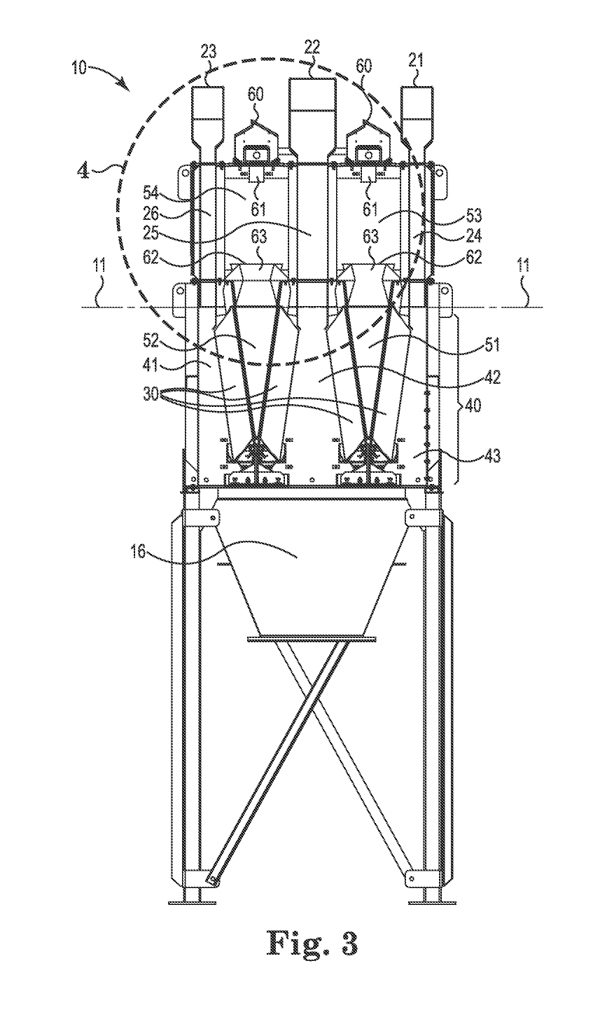

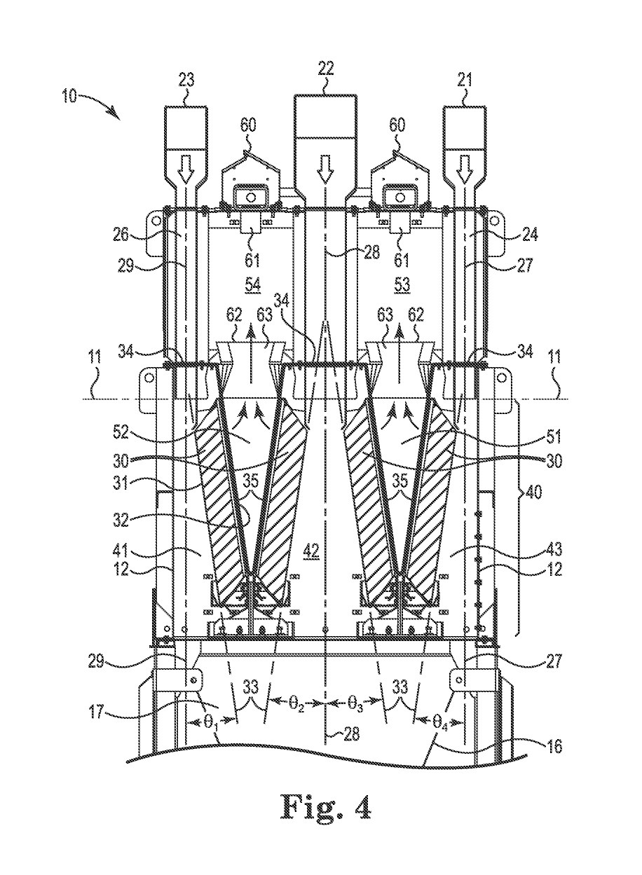

In general, unfiltered or dirty air enters the dust collector 10 through the dirty air inlets 21, 22, and 23. Air filter cartridges 30 (see, e.g., FIGS. 3 and 4) within the dust collector 10 remove dust and other particulate from the dirty air. The dust collected from dirty air flowing through the dust collector 10 falls into the hopper 16 at the bottom of the housing 12 and may be collected in a dust bin or other container located below the hopper 16. The clean, filtered air is exhausted from the dust collector 10 through the clean air outlets 15.

The dust collector 10 includes a tubesheet that separates the interior volume of the dust collector 10 between an unfiltered or dirty air plenum and a filtered or clean air plenum. In one or more embodiments, the tubesheet in the depicted dust collector 10 includes multiple components similar, in many respects, to, e.g., the tubesheet described in connection with International Patent Application No. PCT/US2012/062187 filed on 26 Oct., 2012 and titled SLIDING FILTER CARTRIDGES, DUST COLLECTORS, AND METHODS (in contrast to tubesheets in some dust collectors that may be flat sheets with apertures formed therein).

The tubesheet structure in the depicted dust collector 10 includes (as illustrated in heavy lines in FIG. 4) an upper wall 34 that includes two apertures 63 in which venturis 62 are located for use in connection with the reverse pulse cleaning system as will be described herein. The tubesheet structure in the dust collector 10 also includes lower walls 35 that extend downward into the volume that is otherwise occupied by the dirty air chamber 40 that forms a part of the dirty air plenum of the dust collector 10 as described herein.

Filter cartridges 30 are located over apertures formed in the lower walls 35 of the tubesheet structure. The filter cartridges 30 are positioned such that air passing through the apertures in the lower walls 35 of the tubesheet structure must pass through at least one of the filter cartridges 30 when moving from the dirty air plenum to the clean air plenum as described herein. In other words, the tubesheet structure (including upper wall 34 and lower walls 35), along with the filter cartridges 30, separates the dirty air plenum from the clean air plenum in a manner similar to conventional tubesheets.

Because of the relatively complex nature of the tubesheet structure, the dirty air plenum and the clean air plenum will be described with respect to the various portions or volumes that, together, make up the dirty air plenum and the clean air plenum.

With respect to the dirty air plenum of the illustrative embodiment of a dust collector 10 as seen in FIGS. 1-4, dirty air inlets 21, 22, and 23 are provided in the dust collector 10 and the lead, respectively, to dirty air channels 24, 25, and 26 that deliver dirty air passing through the dirty air inlets 21, 22, and 23 into the dirty air chamber 40. In other words, the dirty air channels 24, 25, and 26 can be described as being located between their respective dirty air inlet and dirty air chamber 40. In one or more embodiments, the dirty air chamber 40 may be described as being located below the tops of the filter cartridges 30 which, as seen in, e.g., FIGS. 3 and 4, i.e., are located below line 11 as depicted in those figures. As seen in, e.g., FIGS. 3-4, the dirty air chamber 40 includes portions located between the sidewalls of the housing 12 and filter cartridges 30. In particular, volume 41 is located on the leftmost side of the views depicted in FIGS. 3-4, while volume 42 is located in the middle of the views depicted in FIGS. 3-4, and volume 43 is located on the rightmost side of those figures. Volume 17 (see, e.g., FIG. 4) located within hopper 16 may also be considered to form a portion of the dirty air chamber 40 in one or more embodiments of dust collectors as described herein.

The clean air plenum of the illustrative embodiment of dust collector 10 as seen in FIGS. 1-4 includes a lower clean air chamber 51 located between the filter cartridges 30 on the right side of the housing 12 in FIGS. 3 and 4, a lower clean air chamber 52 located between the filter cartridges on the left side of the housing 12 in FIGS. 3 and 4. Upper clean air chamber 53 is located above lower clean air chamber 51, and upper clean air chamber 54 located above lower clean air chamber 52. Together, the lower clean air chambers 51 and 52, along with the upper clean air chambers 53 and 54, make up the clean air plenum of the dust collector 10.

In one or more embodiments, the lower clean air chamber 51 and the upper clean air chamber 53 located above the lower clean air chamber 51 may be described as forming a first clean air plenum in the illustrative embodiment of dust collector 10. The lower clean air chamber 52 and the upper clean air chamber 54 located above the lower clean air chamber 52 may be described as forming a second clean air plenum in the illustrative embodiment of dust collector 10. In one or more embodiments, the first clean air plenum may be separate and independent from the second clean air plenum, such that air in the first clean air plenum (which includes, in the depicted embodiment, the lower clean air chamber 51 and upper clean air chamber 53) cannot move into the second clean air plenum (which includes, in the depicted embodiment, the lower clean air chamber 52 and upper clean air chamber 54). In embodiments including multiple clean air plenums that are separate and independent from each other, the dust collectors may include separate and independent clean air outlets such as, e.g., the pair of clean air outlets 15 depicted in FIG. 2.

In one or more embodiments, the upper clean air chambers 53 and 54 may be described as being located above the tops of the filter cartridges 30 as well as their respective lower clean air chamber 51 or 52. As noted above, the tops of the filter cartridges 30 are also denoted in FIGS. 3 and 4 by line 11. Although the tops of all of the filter cartridges 30 are positioned at the same height in the illustrative embodiment depicted in FIGS. 3-4, in one or more alternative embodiments the filter cartridge tops may be located at different heights.

As described herein, the tubesheet structure (including upper wall 34 and lower walls 35 in the illustrative embodiment of FIGS. 3-4) and the filter cartridges 30 located over apertures formed in the lower walls 35 are positioned such that air passing through the apertures in the lower wall 35 of the tubesheet structure must pass through at least one of the filter cartridges 30 when moving from the dirty air plenum into the clean air plenum of the dust collector 10. That air flow is seen in arrows located within the lower clean air chamber 51 and the lower clean air chamber 52.

In the arrangement of filter cartridges 30 as positioned on the tubesheet structure including upper wall 34 and lower walls 35, the clean air faces 32 of the filter cartridges 30 may be described as facing the lower clean air chambers 51 or 52. In one or more embodiments, the clean air face 32 of one of the filter cartridges 30 may be described as facing the clean air face 32 of an opposing filter cartridge 30 located across each of the lower clean air chambers 51 or 52.

In one or more embodiments of dust collectors as described herein, each of the dirty air channels may be described as defining a dirty air flow axis. Further, the filter cartridges may be described as having dirty air faces that face those dirty air flow axes. With respect to the illustrative embodiment depicted in FIG. 4, for example, the leftmost dirty air channel 26 may be described as defining a dirty air flow axis 29 (that, in FIG. 4, is largely vertical). The leftmost filter cartridge 30 may be described as having a dirty air face 31 facing the dirty air flow axis 29. As used in connection with the dirty air channels of dust collectors as described herein, a “dirty air flow axis” is an axis that is aligned with the general direction of airflow through the dirty air channel when the dust collector is operating at its rated volumetric capacity, i.e., when air is directed into the dirty air inlet leading into the dirty air channel and forced through the filter cartridges located over the apertures in the tubesheet structure.

In one or more embodiments, the dirty air channels 24, 25, and 26 may be configured such that dirty air entering the dirty air chamber 40 from each of the dirty air channels 24, 25, and 26 along their respective dirty air flow axes 27, 28, or 29 cannot directly impinge on any of the dirty air faces 31 of the filter cartridges in the dirty air chamber 40 without changing direction in the dirty air chamber 40. Such an arrangement may, in one or more embodiments, be advantageous in that particulate matter that may be entrained in the dirty air flow moving along the dirty air flow axes may be less likely to directly impinge on the filter material forming the dirty air faces of the filter cartridges while moving at those presumably higher velocities immediately upon leaving the dirty air channels. Limiting direct, higher velocity contact of particulates on the filter media may, in one or more embodiments, enhance the service life of filter cartridges in dust collectors as described herein.

As illustrated by axis 33 in FIG. 4, the dirty air face 31 of the filter cartridge 30 facing the dirty air flow axis 29 may, in one or more embodiments, form an included angle θ₁ with the dirty air flow axis 29 that is equal to or greater than zero degrees (0°). In one or more embodiments, the dirty air face 31 may be described as being parallel with the dirty air flow axis 29 or as forming an included angle θ₁ with the dirty air flow air axis 29 that is equal to or greater than zero degrees.

Similar arrangements may, in one or more embodiments, be described with respect to the dirty air faces 31 of the left side filter cartridge 30 volume 42 of the dirty air chamber 40 and the right side filter cartridge 30 facing volume 42 of the dirty air chamber 40. Dirty air channel 25 provides dirty air into the volume 42 along dirty air flow axis 28. The dirty air faces of the filter cartridges 30 facing the dirty air flow axis 28 may, in one or more embodiments, form included angles θ₂ and θ₃ with the dirty air flow axis 28 that are equal to or greater than zero degrees) (0°. In one or more embodiments, the dirty air faces of the filter cartridges 30 facing the volume 42 may be described as being parallel with the dirty air flow axis 28 or as forming an included angle θ₂ or θ₃ with the dirty air flow axis 28 that is equal to or greater than zero degrees.

The rightmost dirty air channel 25 may be described as defining a dirty air flow axis 27 and the rightmost filter cartridge 30 may be described as having a dirty air face facing that dirty air flow axis 27. As illustrated by axis 33, the dirty air face of the filter cartridge 30 facing the dirty air flow axis 27 may, in one or more embodiments, form an included angle θ₄ with the dirty air flow axis 27 that is equal to or greater than zero degrees (0°). In one or more embodiments, the dirty air face of the filter cartridge 30 facing the dirty air flow axis 27 may be described as being parallel with the dirty air flow axis 27 or as forming an included angle θ₄ with the dirty air flow axis 27 that is equal to or greater than zero degrees.

In one or more embodiments of dust collectors as described herein, the included angles formed by the dirty air faces of the filter cartridges with the dirty air flow axes they face may be described as opening in the downward direction towards the dirty air chambers of the dust collectors.

In one or more embodiments of dust collectors as described herein, the included angles (e.g., θ₁, θ₂, θ₃, and θ₄) formed by the dirty air faces of the filter cartridges with the dirty air flow axes (e.g., 27, 28, and 29) they face may be 75 degrees or less. In one or more alternative embodiments, the included angles may be 45 degrees or less, and in one or more other alternative embodiments, the included angles may be 30 degrees or less.

In one or more embodiments, the dirty air faces of the filter cartridges used in dust collectors as described herein may be described as being flat dirty air faces. As used herein with respect to the dirty air faces of filter cartridges, the term “flat” means that the dirty air face of the filter cartridge lies substantially in or near a plane, not that the dirty air face is perfectly planar. Some potentially illustrative embodiments of filter cartridges having flat dirty air faces may be described and depicted in U.S. Pat. Nos. 5,772,883; 5,820,646; and 7,282,075.

In the arrangement of features as depicted in the illustrative embodiment of dust collector 10, dirty air passing through the dirty air channels 24, 25, and 26 along the dirty air flow axes 27, 28, and 29 moves past the tops of the filter cartridges 30 before reaching the dirty air chamber 40. In particular, the dirty air passing through dirty air channel 24 (from dirty air inlet 21 and along the dirty air flow axis 27) moves past the top of the rightmost filter cartridge 30 as seen in FIGS. 3-4. Similarly, dirty air passing through dirty air channel 25 (from dirty air inlet 22 and along the dirty air flow axis 28) moves past the tops of the two middle filter cartridges 30 as seen in FIGS. 3-4. Also, dirty air passing through the dirty air channel 26 (from the dirty air inlet 23 and along the dirty air flow axis 29) moves past the top of the leftmost filter cartridge 30 as seen in FIGS. 3-4.

In one or more embodiments of dust collectors as described herein, dirty air moving through the dirty air channels along the dirty air flow axes 27, 28, and 29 may be described as flowing past the upper clean air chambers 53 and 54 before flowing past the tops of the filter cartridges 30. Such an arrangement may, in one or more embodiments, provide advantages in enhancing the compactness of the dust collectors as described herein, as well as being conducive to orienting the dirty flow axes relative to the dirty air faces of the filter cartridges as described herein. In the illustrative embodiment depicted in, e.g., FIGS. 3 and 4, the dirty air channel 27 may be described as being located on a first side of upper clean air chamber 53, while the dirty air channel 28 may be described as being located on a second side of upper clean air chamber 53. Similarly, dirty air channel 28 may be described as being located on a first side of upper clean air chamber 54, while the dirty air channel 29 may be described as being located on a second side of the upper clean air chamber 54.

When being used to remove particulate matter from air, the filter cartridges 30 become loaded with that particulate matter. One or more embodiments of the dust collectors as described herein may include a reverse pulse cleaning system that is constructed and arranged to emit pulses of air or another gas into the clean air plenum. In particular, the illustrative embodiment of dust collector 10 includes two reverse pulse cleaning systems 60 located above the upper clean air chambers 53 and 54. Each of the reverse pulse cleaning systems 60 includes one or more valves 61 configured to direct pulses of gas downward through the clean air chambers 53 and 54 into and through openings 63 in the upper wall 34 of the tubesheet structure. In one or more embodiments, the dust collectors described herein may include one or more venturis 62 positioned in the upper wall 34. Those venturis 62 may define the openings 63 and help collect and distribute the pulses from the valves 61 towards clean air faces 32 of the filter cartridges 30 of the dust collector 10.

The pulses delivered from the valves 61 through upper clean air chambers 53 and 54 and openings 63 pass through the lower clean air chambers 51 and 52 where they reach the clean air faces 32 of each of the filter cartridges 30. As described herein, clean air faces 32 of the filter cartridges 30 are the surfaces of the filter cartridges 30 that face into the lower clean air chambers 51 and 52 of the clean air plenum.

The pulses delivered from the valves 61 pass through the clean air faces 32 of the filter cartridges 30 to the dirty air faces 31 of the filter cartridges 30. By pulsing air (or another gas or gasses) from the clean air faces 32 through the dirty air faces 31, at least a portion of the dust and other debris clogging the dirty air faces 31 of the air filter cartridges 30 may be dislodged and/or knocked loose from the filter cartridges 30. The dislodged dust and debris falls by gravity into the dust collection hopper 16 where it may collect in, e.g., a collector bin or other receptacle located below the filter cartridges 30.

In one or more embodiments of dust collectors as described herein, the dirty air channels may be described as being separate and independent from each other. For example, the dirty air channel 27 may be separate and independent of the dirty air channel 28 such that dirty air passing through dirty air channel 27 must enter the dirty air chamber 40 before it could enter the dirty air channel 28 (it being understood that in normal operation where dirty air is entering the dust collector through both dirty air channel 27 and dirty air channel 28 such flow would not typically be encountered). Similarly, dirty air passing through the dirty air channel 28 into the dirty air chamber 40 must also enter the dirty air chamber 40 before it could enter the dirty air channel 27.

In one or more embodiments of the dust collectors described herein, the dirty air inlets through which dirty air passes into the dirty air plenum may also be described as being separate and independent of each other. For example, in the illustrative embodiment of dust collector 10 depicted in FIGS. 1-4, the dirty air inlet 21 of dirty air channel 24 is separate and independent of the dirty air inlets 22 and 23 of, respectively, dirty air channels 25 and 26. Because the dirty air inlets are separate and independent of each other, dirty air passing through the dirty air inlet 21 cannot enter either of the dirty air channels 25 or 26 without first passing through the dirty air chamber 40 (although it should be understood that in typical operation, where dirty air is flowing into dirty air chamber 40 from each of the dirty air channels, such reverse flow will typically not be experienced).

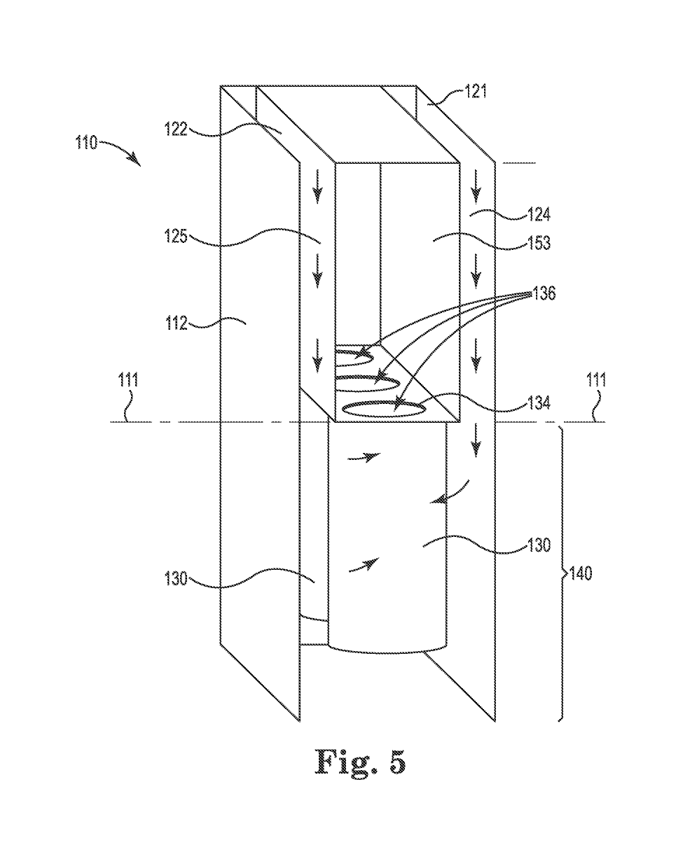

Referring to FIG. 5, one alternative illustrative embodiment of a dust collector 110 is depicted. The illustrative embodiment of dust collector 110 includes a housing 112 in which filter cartridges 130 are attached to a tubesheet 134. The tubesheet 134 separates the housing 112 into a dirty air plenum and a clean air plenum in a manner similar to the tubesheet structure described in connection with the illustrative embodiment of dust collector 10 depicted in FIGS. 1-4.

The dirty air plenum portion of the dust collector 110 includes dirty air channels 124 and 125 through which dirty air flows into a dirty air chamber 140 located below tubesheet 134. Dirty air enters each of the dirty air channels 124 and 125 through one of the dirty air inlets 121 and 122.

The tubesheet 134 of the illustrative embodiment of dust collector 110 includes apertures 136. Filter cartridges 130, also located in the housing 112, are, in one or more embodiments, positioned such that air passing through the apertures 136 in the tubesheet 134 must pass through at least one of the filter cartridges 130. In the depicted embodiment, the filter cartridges 130 may be described as being generally tubular. As a result, each of the filter cartridges 130 defines a lower clean air chamber within its enclosed volume and below the aperture 136 over which the filter cartridge 130 is attached. The filter cartridges 130 may also be described as having a clean air face facing inward towards the lower clean air chamber defined within each of the filter cartridges 130, as well as a dirty air face facing outward away from the lower clean air chamber and towards the surrounding walls of the housing 112 of the dust collector 110 within the dirty air chamber 140.

An upper clean air chamber 153 is located above the lower clean air chambers in each of the filter cartridges 130 as well as above the tubesheet 134 and its apertures 136. The lower clean air chambers located in each of the filter cartridges 130 may be described, in one or more embodiments, as being located below the upper clean air chamber 153. The lower clean air chambers in each of the filter cartridges 130 and the upper clean air chamber 153 may be described as, together, constituting the clean air plenum of the illustrative embodiment of dust collector 110.

In the depicted embodiment of dust collector 110, dirty air moving through the dirty air channels 124 and 125 along the dirty air flow axes defined by those channels may be described as flowing past the upper clean air chamber 153 before reaching the dirty air chamber 140. In one or more embodiments, the dirty air chamber 140 may be described as being located below the tops of the filter cartridges 130 which, in the depicted embodiment, are located along a line 111 as seen in FIG. 5. In a similar manner, dirty air passing through the dirty air channels 124 and 125 may be described as moving past the tops of the filter cartridges 130 before reaching the dirty air chamber 140 in the dust collector 110.

In one or more embodiments, the dirty air channels 124 and 125 may be configured such that dirty air entering the dirty air chamber 140 from each of the dirty air channels 124 and 125 along their respective dirty air flow axes cannot directly impinge on any of the dirty air faces of the filter cartridges 130 in the dirty air chamber 140 without changing direction in the dirty air chamber 140. Such an arrangement may, in one or more embodiments, be advantageous in that particulate matter that may be entrained in the dirty air flow moving along the dirty air flow axes may be less likely to directly impinge on the filter material forming the dirty air faces of the filter cartridges while moving at those presumably higher velocities immediately upon leaving the dirty air channels. Limiting direct, higher velocity contact of particulates on the filter media may, in one or more embodiments, enhance the service life of filter cartridges in dust collectors as described herein.

In one or more embodiments, the portions of the dirty air faces of the filter cartridges 130 facing the dirty air flow axes defined by the dirty air flow channels 124 and 125 may form included angles with the dirty air flow axes that are equal to or greater than zero degrees (0°). In one or more embodiments, the dirty air faces of the filter cartridges 130 may be described as being parallel with the dirty air flow axes or forming included angles with the dirty air flow axes that are equal to or greater than zero degrees.

In one or more embodiments of dust collectors similar to illustrative dust collector 110, the included angles formed by the dirty air faces of the filter cartridges 130 with the dirty air flow axes they face may be described as opening in the downward direction towards the dirty air chamber 140.

In one or more embodiments of dust collectors as described herein, the included angles formed by the dirty air faces of the filter cartridges 130 with the dirty air flow axes defined by the dirty air flow chambers 124 and 125 they face may be 75 degrees or less. In one or more alternative embodiments, the included angles may be 45 degrees or less, and in one or more other alternative embodiments, the included angles may be 30 degrees or less.

Although the depicted embodiment of dust collector 110 includes three filter cartridges 130 and corresponding apertures 136 in tubesheet 134, in one or more alternative embodiments, the dust collector may include as few as one filter cartridge, two filter cartridges, or four or more filter cartridges. Furthermore, although each filter cartridge 130 is depicted as being located over its own single aperture 136, in one or more alternative embodiments, a filter cartridge 130 may be located over two or more apertures in a tubesheet.

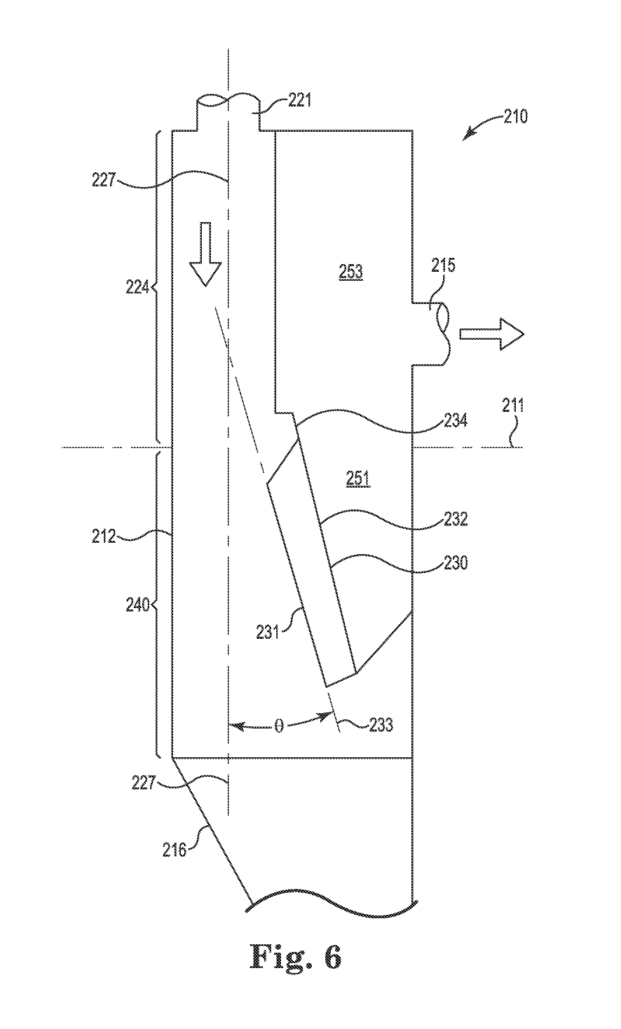

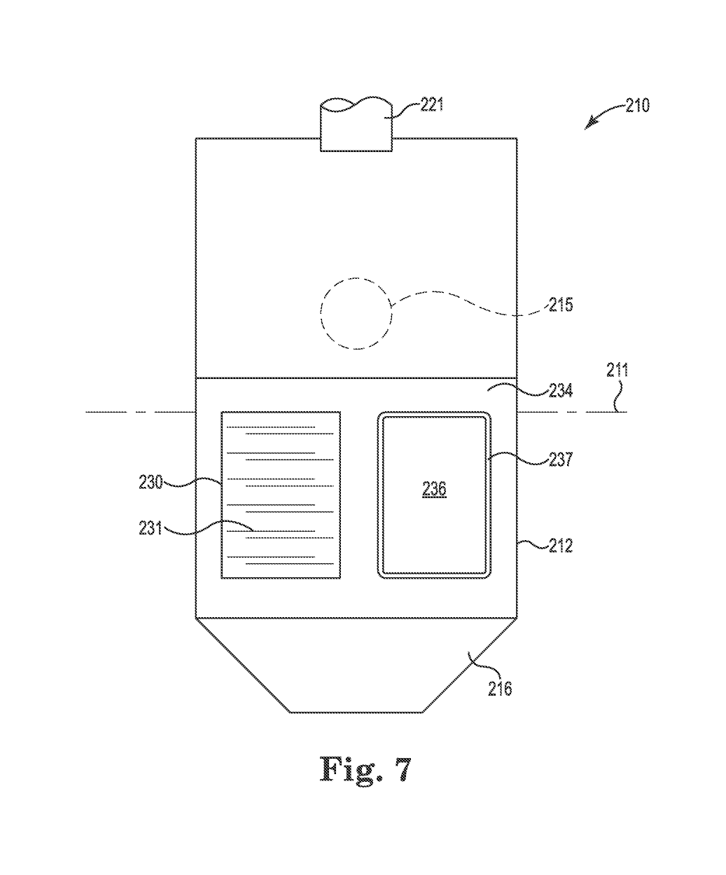

Another illustrative embodiment of a dust collector 210 is depicted in FIGS. 6 and 7. The dust collector 210 uses filter cartridges 230 to remove dust and other types of particulate from air. The dust collector 210 also includes a housing 212 with dirty air entering the housing 212 through a dirty air inlet 221 and clean air leaving the housing 212 through clean air outlet 215. A hopper 216 is located below the filter cartridges 230. A tubesheet 234 separates the housing 212 into a dirty air plenum and a clean air plenum.

In the illustrative embodiment of dust collector 210, dirty air plenum includes both a dirty air channel 224 and a dirty air chamber 240. Dirty air entering the dust collector 210 through dirty air inlet 221 passes through dirty air channel 224 on its way to dirty air chamber 240. As in the other illustrative embodiments of dust collectors as described herein, the dirty air chamber 240 may be described as being located below the tops of the filter cartridges 230 provided in the dust collector 210. Dirty air channel 224 may, as also described in connection with other illustrative embodiments described herein, define a dirty air flow axis 227 along which dirty travels when entering the dirty air chamber 240.

The clean air plenum, in the illustrative embodiment of dust collector 210, includes a lower clean air chamber 251 and an upper clean air chamber 253. The upper clean air chamber 253 may be described, in one or more embodiments, as being located above a top of the filter cartridges 230 and the lower clean air chamber 251 may be described as being located below the upper clean air chamber 253 and the tops of the filter cartridges 230 (with those tops being, in the depicted illustrative embodiment, aligned with the line 211).

Given their relative positions in the dust collector 210, dirty air moving through the dirty air channel 224 along the dirty air flow axis 227 from the dirty air inlet 221 to the dirty air chamber 240 flows past the upper clean air chamber 253. The dirty air passing through the dirty air channel 224 along the dirty air flow axis 227 may also be described as moving past the tops of the filter cartridges 230 before reaching the dirty air chamber 240.

The tubesheet 234 includes apertures 236 through which air passes when moving from the dirty air chamber 240 of the dirty air plenum into the clean air plenum 250. In the view seen in FIG. 7, one of the apertures 236 is depicted as uncovered by a filter cartridge 230 while a second aperture is covered by filter cartridge 230. Because the filter cartridges are located over apertures 236 in the tubesheet 234, air passing through the apertures 236 from the dirty air plenum into the clean air plenum must pass through at least one of the filter cartridges 230. Although the illustrative embodiment of dust collector 210 includes two filter cartridges 230 and corresponding apertures 236 in tubesheet 234, in one or more embodiments, the dust collectors described herein may include any number of filter cartridges, with each filter cartridge being located over one or more apertures in a tubesheet.

The aperture 236 in the tubesheet 234 includes, in the depicted embodiment, a gasket or other sealing mechanism 237 that may be used to seal the filter cartridge over the opening 236 such that dirty air must pass through the filter cartridges before entering the clean air plenum. Such gaskets or other seal structures are known and will not be described further herein.

The filter cartridge 230 depicted in, e.g., FIG. 6, includes a dirty air face 231 facing the dirty air chamber 240 of the dirty air plenum and a clean air face 232 facing the lower clean air chamber 251 of the clean air plenum. As described herein, one or more embodiments of the dust collectors may include dirty air channels that define one or more dirty air flow axes. With respect to the illustrative embodiment of dust collector 210 depicted in FIG. 6, for example, the dirty air channel 224 may be described as defining a dirty air flow axis 227. The filter cartridges 230 may be described as having dirty air faces 231 facing the dirty air flow axis 227.

In one or more embodiments, the dirty air channel 224 may be configured such that dirty air entering the dirty air chamber 240 from the dirty air channel 224 along the dirty air flow axis 227 cannot directly impinge on the dirty air faces 231 of the filter cartridges 230 in the dirty air chamber 240 without changing direction in the dirty air chamber 240. Such an arrangement may, in one or more embodiments, be advantageous in that particulate matter that may be entrained in the dirty air flow moving along the dirty air flow axes may be less likely to directly impinge on the filter material forming the dirty air faces of the filter cartridges while moving at those presumably higher velocities immediately upon leaving the dirty air channels. Limiting direct, higher velocity contact of particulates on the filter media may, in one or more embodiments, enhance the service life of filter cartridges in dust collectors as described herein.

As illustrated by axis 233 in FIG. 6, the dirty air face 231 of a filter cartridge 230 facing the dirty air flow axis 227 may, in one or more embodiments, form an included angle θ with the dirty air flow axis 227 that is equal to or greater than zero degrees (0°). In one or more embodiments, the dirty air face 231 may be described as being parallel with the dirty air flow axis 227 or forming an included angle θ with the dirty air flow air axis 227 that is equal to or greater than zero degrees.

In one or more embodiments of dust collectors as described herein, the included angles formed by the dirty air faces 231 of the filter cartridges 230 with the dirty air flow axis 227 they face may be described as opening in the downward direction towards the dirty air chamber 240.

In one or more embodiments of dust collectors as described herein, the included angles formed by the dirty air faces 231 of the filter cartridges 230 with the dirty air flow axis 227 they face may be 75 degrees or less. In one or more alternative embodiments, the included angles may be 45 degrees or less, and in one or more other alternative embodiments, the included angles may be 30 degrees or less.

In one or more embodiments of the dust collectors as described herein, the arrangement and orientation of the dirty air flow axes defined by dirty air flow channels may be described as not intersecting any dirty air faces of filter cartridges contained in the dirty air chambers of the dust collectors.

Specific construction details with respect to the filter cartridges described herein may vary. Examples of some potential suitable filter cartridge constructions including, e.g., media packs and frames/structures containing the media packs may be found in one or more of the following documents: U.S. Pat. Nos. 4,925,561; 5,049,326; 5,562,825; 5,613,992; 5,772,883; 5,792,247; 5,820,646; 5,895,574; 5,902,364; 6,039,778; 6,179,890; 6,190,432; 6,210,469; 6,235,195; 6,350,296; 6,673,136; 7,282,075; 7,959,702; Des. 396,098; Des. 398,046; Des. 399,944; Des. 428,128; and Des. 437,401; International Publications WO 1997/040918; WO 2004/007054; WO 2004/082795; and US Patent Application Publications US 2006/0091084; US 2010/0078379; and US 2009/0127211.

Illustrative embodiments of dust collectors and related methods as described herein are discussed and reference has been made to some possible variations. These and other variations and modifications in the invention will be apparent to those skilled in the art without departing from the scope of the invention, and it should be understood that this invention is not limited to the illustrative embodiments set forth herein. Accordingly, this invention is not limited to the above-described embodiments, but is to be controlled by the limitations set forth in the following claims and any equivalents thereof. This invention also may be suitably practiced in the absence of any element not specifically disclosed as necessary herein.

All patents, patent applications and other documents cited herein are incorporated by reference into this document in total. To the extent there is a conflict or discrepancy between this document and the disclosure in any such incorporated document, this document will control.

What is claimed is:

1. A dust collector comprising:
an aperture formed through a tubesheet structure located in a housing;
a filter cartridge located in the housing, wherein the filter cartridge is positioned such that air passing through the aperture in the tubesheet structure must pass through the filter cartridge, wherein the tubesheet structure and the filter cartridge separate the housing into a clean air plenum and a dirty air plenum, and wherein air passing through the aperture must pass through the filter cartridge;
wherein the dirty air plenum comprises a dirty air channel located above a dirty air chamber, wherein the dirty air channel is located between a dirty air inlet through which dirty air enters the dirty air plenum and the dirty air chamber, wherein the dirty air chamber is located below a top of the filter cartridge, and wherein the dirty air channel defines a dirty air flow axis through the dirty air channel;
wherein the clean air plenum comprises an upper clean air chamber located above the top of the filter cartridge and a lower clean air chamber located below the upper clean air chamber and the top of the filter cartridge, wherein the filter cartridge comprises a dirty air face facing away from the lower clean air chamber, and wherein dirty air moving through the dirty air channel from the dirty air inlet to the dirty air chamber along the dirty air flow axis flows past the upper clean air chamber;
and wherein dirty air passing downward through the dirty air channel along the dirty air flow axis moves past a top of the filter cartridge before reaching the dirty air chamber;
and further wherein the dirty air channel is configured such that dirty air entering the dirty air chamber from the dirty air channel along the dirty air flow axis cannot directly impinge on the dirty air face of the filter cartridge without changing direction in the dirty air chamber.

2. A dust collector according to claim 1, wherein the clean air plenum comprises a lower clean air chamber located below the top of the filter cartridge and the aperture in the tubesheet, wherein a clean air face of the filter cartridge faces the lower clean air chamber, and wherein the dirty air face of the filter cartridge faces away from the lower clean air chamber.

3. A dust collector according to claim 2, wherein the filter cartridge comprises a tubular filter cartridge comprising a cartridge opening located over the aperture in the tubesheet.

4. A dust collector according to claim 2, wherein a portion of the dirty air face of the filter cartridge faces the dirty air flow axis, and wherein the dirty air flow axis is parallel with the portion of the dirty air face of the filter cartridge or forms an included angle equal to or greater than zero degrees with the portion of the dirty air face of the filter cartridge, wherein the included angle opens in the downward direction towards the dirty air chamber.

5. A dust collector according to claim 4, wherein the dirty air flow axis forms an included angle of 75 degrees or less with the portion of the dirty air face of the filter cartridge.

6. A dust collector according to claim 1, wherein the aperture formed through the tubesheet structure comprises a first aperture of a plurality of apertures formed through the tubesheet structure, and wherein the plurality of apertures comprises a second aperture;
and wherein the filter cartridge comprises a first filter cartridge of a plurality of filter cartridges located in the housing, wherein the plurality of filter cartridges are positioned such that air passing through the plurality of apertures in the tubesheet structure must pass through at least one filter cartridge of the plurality of filter cartridges, wherein the tubesheet structure and the plurality of filter cartridges separate the housing into a clean air plenum and a dirty air plenum, and wherein the plurality of filter cartridges comprises a second filter cartridge, and further wherein air passing through the first aperture must pass through the first filter cartridge and air passing through the second aperture must pass through the second filter cartridge.

7. A dust collector according to claim 6, wherein dirty air passing downward through the dirty air channel along the dirty air flow axis moves past a top of the second filter cartridge before reaching the dirty air chamber.

8. A dust collector according to claim 6, wherein the clean air plenum comprises:
a first lower clean air chamber located below the top of the first filter cartridge and the first aperture in the tubesheet, wherein a clean air face of the first filter cartridge faces the first lower clean air chamber, and wherein the dirty air face of the first filter cartridge faces away from the first lower clean air chamber; and
a second lower clean air chamber located below the top of the second filter cartridge and the second aperture in the tubesheet, wherein a clean air face of the second filter cartridge faces the second lower clean air chamber, and wherein a dirty air face of the second filter cartridge faces away from the second lower clean air chamber.

9. A dust collector according to claim 8, wherein the first filter cartridge comprises a tubular filter cartridge comprising a cartridge opening located over the first aperture in the tubesheet, and wherein the second filter cartridge comprises a tubular filter cartridge comprising a cartridge opening located over the second aperture in the tubesheet.

10. A dust collector according to claim 8, wherein a portion of the dirty air face of the first filter cartridge faces the dirty air flow axis, and wherein the dirty air flow axis is parallel with the portion of the dirty air face of the first filter cartridge or forms an included angle equal to or greater than zero degrees with the portion of the dirty air face of the first filter cartridge, wherein the included angle opens in the downward direction towards the dirty air chamber.

11. A dust collector according to claim 10, wherein the dirty air flow axis forms an included angle of 75 degrees or less with the portion of the dirty air face of the first filter cartridge.

12. A dust collector according to claim 6, wherein a clean air face of the first filter cartridge faces the lower clean air chamber, and wherein a clean air face of the second filter cartridge faces the lower clean air chamber.

13. A dust collector according to claim 12, wherein the clean air face of the first filter cartridge faces the clean air face of the second filter cartridge across the lower clean air chamber.

14. A dust collector according to claim 12, wherein the first filter cartridge comprises a flat dirty air face facing the dirty air flow axis, and wherein the dirty air flow axis is parallel with the flat dirty air face of the first filter cartridge or forms an included angle equal to or greater than zero degrees with the flat dirty air face of the first filter cartridge, wherein the included angle opens in the downward direction towards the dirty air chamber.

15. A dust collector according to claim 14, wherein the dirty air flow axis forms an included angle of 75 degrees or less with the flat dirty air face of the first filter cartridge.

16. A dust collector according to claim 1, wherein the aperture formed through the tubesheet structure comprises a first aperture of a plurality of apertures formed through the tubesheet structure, and wherein the plurality of apertures comprises a second aperture;
wherein the filter cartridge comprises a first filter cartridge of a plurality of filter cartridges located in the housing, wherein the plurality of filter cartridges are positioned such that air passing through the plurality of apertures in the tubesheet structure must pass through at least one filter cartridge of the plurality of filter cartridges, wherein the tubesheet structure and the plurality of filter cartridges separate the housing into a clean air plenum and a dirty air plenum, and wherein the plurality of filter cartridges comprises a second filter cartridge, and further wherein air passing through the first aperture must pass through the first filter cartridge and air passing through the second aperture must pass through the second filter cartridge;
wherein the dirty air channel comprises a first dirty air channel of a plurality of dirty air channels in the dirty air plenum and the dirty air flow axis comprises a first dirty air flow axis in the first dirty air channel, wherein the plurality of dirty air channels are located above the dirty air chamber, wherein the plurality of dirty air channels comprises a second dirty air channel, wherein dirty air flowing downward through the second dirty air channel defines a second dirty air flow axis;
and wherein dirty air moving downward through the first dirty air channel from the dirty air inlet to the dirty air chamber along the first dirty air flow axis flows past the upper clean air chamber before flowing past the top of the first filter cartridge, and wherein dirty air moving downward through the second dirty air channel from the dirty air inlet to the dirty air chamber along the second dirty air flow axis flows past the upper clean air chamber before flowing past a top of the second filter cartridge.

17. A dust collector according to claim 16, wherein the first dirty air channel is located on a first side of the upper clean air chamber and the second dirty air channel is located on a second side of the upper clean air chamber.

18. A dust collector according to claim 16, wherein the first dirty air channel is separate and independent of the second dirty air channel such that dirty air passing through the first dirty air channel must enter the dirty air chamber before it can enter the second dirty air channel.

19. A dust collector according to claim 16, wherein the first dirty air channel comprises a first dirty air inlet and the second dirty air channel comprises a second dirty air inlet, and further wherein the first dirty air inlet is separate and independent of the second dirty air inlet such that dirty air passing through the first dirty air inlet cannot enter the second dirty air channel unless it passes through the dirty air chamber first and dirty air passing through the second dirty air inlet cannot enter the first dirty air channel unless it passes through the dirty air chamber first.

20. A dust collector according to claim 16, wherein a clean air face of the first filter cartridge faces the lower clean air chamber and a clean air face of the second filter cartridge faces the lower clean air chamber.

21. A dust collector according to claim 20, wherein a clean air face of the first filter cartridge faces a clean air face of the second filter cartridge across the lower clean air chamber.

22. A dust collector according to claim 16, wherein the first filter cartridge comprises a flat dirty air face, and wherein the first dirty air flow axis is parallel with the flat dirty air face of the first filter cartridge or forms an included angle equal to or greater than zero degrees with the flat dirty air face of the first filter cartridge, wherein the included angle opens in the downward direction towards the dirty air chamber.

23. A dust collector according to claim 22, wherein the first dirty air flow axis forms an included angle of 75 degrees or less with the flat dirty air face of the first filter cartridge.

24. A dust collector according to claim 1, wherein the dust collector further comprises a pulse jet cleaning system comprising a plurality of nozzles configured to deliver pulses of cleaning gas into the clean air plenum.

25. A dust collector comprising:
a plurality of apertures formed through a tubesheet structure located in a housing, wherein the plurality of apertures comprise a first aperture, a second aperture, a third aperture, and a fourth aperture; and
a plurality of filter cartridges located in the housing, wherein the plurality of filter cartridges are positioned such that air passing through the plurality of apertures in the tubesheet structure must pass through at least one filter cartridge of the plurality of filter cartridges, wherein the tubesheet structure and the plurality of filter cartridges separate the housing into a first clean air plenum, a second clean air plenum, and a dirty air plenum, and wherein the plurality of filter cartridges comprises a first filter cartridge, a second filter cartridge, a third filter cartridge, and a fourth filter cartridge, and further wherein air passing through the first aperture into the first clean air plenum must pass through the first filter cartridge, air passing through the second aperture into the first clean air plenum must pass through the second filter cartridge, air passing through the third aperture into the second clean air plenum must pass through the third filter cartridge, and air passing through the fourth aperture into the second clean air plenum must pass through the fourth filter cartridge, and further wherein the first filter cartridge comprises a dirty air face facing away from the first clean air plenum, the second filter cartridge comprises a dirty air face facing away from the first clean air plenum, the third filter cartridge comprises a dirty air face facing away from the second clean air plenum, and the fourth filter cartridge comprises a dirty air face facing away from the second clean air plenum;
wherein the first clean air plenum comprises a first upper clean air chamber located above a top of the first filter cartridge, and wherein the second clean air plenum comprises a second upper clean air chamber located above a top of the third filter cartridge;
wherein the dirty air plenum comprises a plurality of dirty air channels located above a dirty air chamber, wherein each dirty air channel of the plurality of dirty air channels is located between a dirty air inlet and the dirty air chamber, and wherein a first dirty air channel of the plurality of dirty air channels is located between the first upper clean air chamber and a first sidewall of the housing, a second dirty air channel of the plurality of dirty air channels is located between the first and second upper clean air chambers, and a third dirty air channel of the plurality of dirty air channels is located between the second upper clean air chamber and a second sidewall of the housing, and wherein the first dirty air flow channel defines a first dirty air flow axis, the second dirty air flow channel defines a second dirty air flow axis, and the third dirty air flow channel defines a third dirty air flow axis;
wherein the first dirty air channel is configured such that dirty air entering the dirty air chamber along the first dirty air flow axis from the first dirty air channel cannot directly impinge on the dirty air face of any of the first filter cartridge, the second filter cartridge, the third filter cartridge, or the fourth filter cartridge without changing direction in the dirty air chamber;
wherein the second dirty air channel is configured such that dirty air entering the dirty air chamber along the second dirty air flow axis from the second dirty air channel cannot directly impinge on the dirty air face of any of the first filter cartridge, the second filter cartridge, the third filter cartridge, or the fourth filter cartridge without changing direction in the dirty air chamber;
wherein the third dirty air channel is configured such that dirty air entering the dirty air chamber along the third dirty air flow axis from the third dirty air channel cannot directly impinge on the dirty air face of any of the first filter cartridge, the second filter cartridge, the third filter cartridge, or the fourth filter cartridge without changing direction in the dirty air chamber.

26. A dust collector according to claim 25, wherein the first dirty air channel, the second dirty air channel, and the third dirty air channel are all separate and independent from each other such that dirty air passing through the first dirty air channel must enter the dirty air chamber before it can enter the second dirty air channel or the third dirty air channel.

27. A dust collector according to claim 25, wherein the first dirty air channel comprises a first dirty air inlet, the second dirty air channel comprises a second dirty air inlet, and the third dirty air channel comprises a third dirty air inlet, and further wherein the first dirty air inlet, the second dirty air inlet, and the third dirty air inlet are separate and independent from each other such that dirty air passing through the first dirty air inlet cannot enter the second dirty air channel or the third dirty air channel unless it passes through the dirty air chamber first, wherein dirty air passing through the second dirty air inlet cannot enter the first dirty air channel or the third dirty air channel unless it passes through the dirty air chamber first, and wherein dirty air passing through the third dirty air inlet cannot enter the first dirty air channel or the second dirty air channel unless it passes through the dirty air chamber first.

28. A dust collector according to claim 25, wherein the first clean air plenum comprises a first lower clean air chamber located below the first upper clean air chamber, wherein a clean air face of the first filter cartridge faces a clean air face of the second filter cartridge across the first lower clean air chamber of the first clean air plenum;
and wherein the second clean air plenum comprises a second lower clean air chamber located below the second upper clean air chamber, wherein a clean air face of the third filter cartridge faces a clean air face of the fourth filter cartridge across the second lower clean air chamber of the second clean air plenum.

29. A dust collector according to claim 25, wherein the first filter cartridge comprises a flat dirty air face, and wherein the first dirty air flow axis is parallel with the flat dirty air face of the first filter cartridge or forms a first included angle equal to or greater than zero degrees with the flat dirty air face of the first filter cartridge, wherein the first included angle opens in the downward direction towards the dirty air chamber.

30. A dust collector according to claim 29, wherein the second filter cartridge comprises a flat dirty air face, and wherein the second dirty air flow axis is parallel with the flat dirty air face of the second filter cartridge or forms a second included angle equal to or greater than zero degrees with the flat dirty air face of the second filter cartridge, wherein the second included angle opens in the downward direction towards the dirty air chamber;
and further wherein the third filter cartridge comprises a flat dirty air face, and wherein the second dirty air flow axis is parallel with the flat dirty air face of the third filter cartridge or forms a third included angle equal to or greater than zero degrees with the flat dirty air face of the third cartridge, wherein the third included angle opens in the downward direction towards the dirty air chamber.

31. A dust collector according to claim 30, wherein the fourth filter cartridge comprises a flat dirty air face, and wherein the third dirty air flow axis is parallel with the flat dirty air face of the fourth filter cartridge or forms a fourth included angle equal to or greater than zero degrees with the flat dirty air face of the fourth filter cartridge, wherein the fourth included angle opens in the downward direction towards the dirty air chamber.

32. A dust collector according to claim 29, wherein one or more of the first, second, third, and fourth included angles is 75 degrees or less.

33. A dust collector according to claim 25, wherein the dust collector further comprises a first pulse jet cleaning system comprising a first plurality of valves configured to deliver pulses of cleaning gas into the first clean air plenum, and a second pulse jet cleaning system comprising a second plurality of valves configured to deliver pulses of cleaning gas into the second clean air plenum.

34. A dust collector according to claim 25, wherein clean air exits from the first clean air plenum through a first clean air outlet, and wherein clean air exits from the second clean air plenum through a second clean air outlet.

35. A method of removing particulates from dirty air, the method comprising:
passing dirty air into a dirty air plenum of a housing, the dirty air plenum comprising a dirty air inlet, a dirty air channel, and a dirty air chamber, wherein the dirty air passes into the housing through the dirty air inlet and then downward through the dirty air channel along a dirty air flow axis before reaching the dirty air chamber;
passing the dirty air in the dirty air chamber through a filter cartridge located over an aperture in a tubesheet structure that separates the dirty air plenum from a clean air plenum located in the housing, wherein particulates in the dirty air are removed from the dirty air by the filter cartridge before passing into the clean air plenum;
wherein the dirty air chamber is located below a top of the filter cartridge;
wherein the clean air plenum comprises an upper clean air chamber located above the top of the filter cartridge and a lower clean air chamber located below the upper clean air chamber and the top of the filter cartridge, wherein the filter cartridge comprises a dirty air face facing away from the lower clean air chamber, and wherein the dirty air moving through the dirty air channel from the dirty air inlet to the dirty air chamber along the dirty air flow axis flows past the upper clean air chamber;
and wherein the dirty air passing through the dirty air channel along the dirty air flow axis moves downward past a top of the filter cartridge before reaching the dirty air chamber;
and further wherein the dirty air entering the dirty air chamber from the dirty air channel along the dirty air flow axis cannot directly impinge on the dirty air face of the filter cartridge without changing direction in the dirty air chamber.

36. A method according to claim 35, wherein the clean air plenum comprises a lower clean air chamber located below the top of the filter cartridge and the aperture in the tubesheet, wherein a clean air face of the filter cartridge faces the lower clean air chamber, and wherein the dirty air face of the filter cartridge faces away from the lower clean air chamber.

37. A method according to claim 36, wherein the filter cartridge comprises a tubular filter cartridge comprising a cartridge opening located over the aperture in the tubesheet.

38. A method according to claim 36, wherein a portion of the dirty air face of the filter cartridge faces the dirty air flow axis, and wherein the dirty air flow axis is parallel with the portion of the dirty air face of the filter cartridge or forms an included angle equal to or greater than zero degrees with the portion of the dirty air face of the filter cartridge, wherein the included angle opens in the downward direction towards the dirty air chamber.

39. A method according to claim 38, wherein the dirty air flow axis forms an included angle of 75 degrees or less with the portion of the dirty air face of the filter cartridge.
